(19) United States
(12) Patent Application Publication
(10) Pub. No.: US 2016/0136663 A1
(43) Pub. Date: May 19, 2016

(54) METHOD FOR LINING A PIPE WITH A CEMENT MORTAR

(71) Applicant: American SpiralWeld Pipe Company LLC, Columbia, SC (US)

(72) Inventor: Michael David Smith, Lexington, SC (US)

(73) Assignee: AMERICAN SPIRALWELD PIPE COMPANY LLC, Columbia, SC (US)

(21) Appl. No.: 14/934,947

(22) Filed: Nov. 6, 2015

Related U.S. Application Data
(60) Provisional application No. 62/080,658, filed on Nov. 17, 2014.

(51) Int. Cl. B05B 9/00; B05D 1/02

(52) U.S. Cl. CPC B05B 9/007; B05D 1/02; B05D 2254/04

(57) ABSTRACT

The present invention provides a mobile cart for lining a section of water main pipe having an interior surface. The mobile cart comprising a wheeled platform with a mixer operatively connected to the wheeled platform; a discharge pump operatively connected to the wheeled platform; and a lance operatively connected to the wheeled platform.

### CROSS REFERENCES TO RELATED APPLICATIONS

This application claims priority from and is related to commonly owned U.S. Provisional Patent Application Ser. No. 62/080,658 filed Nov. 17, 2014, entitled: METHOD FOR LINING A PIPE WITH A CEMENT MORTAR, this Provisional Patent Application incorporated by reference herein.

### TECHNICAL FIELD

The present invention relates to an improved method and apparatus for lining a section of pipe with a cement-mortar.

### BACKGROUND OF THE INVENTION

DSAW (dual submerged arc welded) steel pipe is used in the water, wastewater, power, structural and industrial markets. A large percentage of the steel pipe that is produced in the industry for water transmission receives a cement-mortar lining as part of post steel pipe production lining and coating operations.

The standard in the industry for cement-mortar lining steel pipe is to have some sort of stationary equipment, similar to that used by commercial concrete suppliers, in order to mix raw materials (sand, cement & water). In such processes, once mixed, the fluid cement-mortar mixture is then poured into mobile equipment (cart) for transportation to and discharge at the rotating pipe application location (centrifuge). The steel pipe is positioned inside the centrifuge and rotated at very high RPMs (revolutions per minute). The mobile cart then pumps the fluid cement mixture into the pipe at an even rate depositing the cement in a uniform manner around the ID (inner diameter) of the pipe. The mixture discharge rate coupled with the machine withdrawal rate yields a quantity of mixture delivered per unit length of pipe, resulting in the desired final mixture thickness.

Therefore, what is needed is a method and apparatus which can be used to improve the process of lining steel pipe with cement-mortar.

Nothing in the prior art provides the benefits attendant with the present invention.

An object of the present invention is to provide a mobile cart for lining a section of water main pipe having an interior surface comprising: a wheeled platform; a mixer operatively connected to said wheeled platform; a discharge pump operatively connected to said wheeled platform; and a lance operatively connected to said wheeled platform.

Another object of the present invention is to provide a mobile cart for lining a section of water main pipe having an interior surface comprising: a wheeled platform; a mixer operatively connected to said wheeled platform; a discharge pump operatively connected to said wheeled platform; a lance operatively connected to said wheeled platform; a tower operatively connected to said lance; a control panel operatively connected to said wheeled platform; at least one positioning motor operatively connected to said tower; at least one translational drive motor operatively connected to said wheeled platform; at least one proximity switch operatively connected to said wheeled platform; at least one programmable logic controller operatively connected to said wheeled platform; an integrated load cell operatively connected to said wheeled platform; a jack screw operatively connected to said lance; at least one bin operatively connected to said wheeled platform; at least one speed sensor operatively connected to said wheeled platform; at least one volume of mixture sensor operatively connected to said lance; at least one quantity of raw material sensor operatively connected to said mixer; and at least one moisture sensor operatively connected to said mixer.

Yet another object of the present invention is to provide a method for using a mobile cart for lining a section of water main pipe having an interior surface comprising: providing a wheeled platform having a mixer, a discharge pump, and a lance; discharging a high-slump cement-mortar mixture from said lance of said wheeled platform to an inside of a pipe that is being rotated about its centerline axis, said cement-mortar mixture being discharged at a predetermined rate from said lance into the rotating pipe; and withdrawing said lance from the inside of the pipe at a predetermined rate using said wheeled platform.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

A feature of the present invention is to provide a mobile cart for lining a section of water main pipe having an interior surface. The mobile cart comprising a wheeled platform with a mixer operatively connected to the wheeled platform. A discharge pump is operatively connected to the wheeled platform. A lance is operatively connected to the wheeled platform. A tower can be operatively connected to the lance. A control panel can be operatively connected to the wheeled platform. At least one positioning motor can be operatively connected to the tower. At least one translational drive motor can be operatively connected to the wheeled platform. At least one proximity switch can be operatively connected to the wheeled platform. At least one programmable logic controller can be operatively connected to the wheeled platform. An integrated load cell can be operatively connected to the wheeled platform. A jack screw can be operatively connected to the lance. At least one bin can be operatively connected to the wheeled platform. At least one speed sensor can be operatively connected to the wheeled platform. At least one volume of mixture sensor can be operatively connected to the lance. At least one quantity of raw material sensor can be operatively connected to the mixer. At least one moisture sensor can be operatively connected to the mixer.

Another feature of the present invention is to provide a mobile cart for lining a section of water main pipe having an interior surface comprising a wheeled platform with a mixer operatively connected to the wheeled platform. A discharge pump is operatively connected to the wheeled platform. A lance is operatively connected to the wheeled platform. A tower is operatively connected to the lance. A control panel is operatively connected to the wheeled platform. At least one positioning motor is operatively connected to the tower. At least one translational drive motor is operatively connected to the wheeled platform. At least one proximity switch is operatively connected to the wheeled platform. At least one programmable logic controller is operatively connected to the wheeled platform. An integrated load cell is operatively connected to the wheeled platform. A jack screw is operatively connected to the lance. At least one bin is operatively connected to the wheeled platform. At least one speed sensor is operatively connected to the wheeled platform. At least one volume of mixture sensor is operatively connected to the lance. At least one quantity of raw material sensor is operatively connected to the mixer. At least one moisture sensor is operatively connected to the mixer.

Yet another feature of the present invention is to provide a method for using a mobile cart for lining a section of water main pipe having an interior surface. The method comprising the steps of providing a wheeled platform having a mixer, a discharge pump, and a lance. A high-slump cement-mortar mixture is discharged from the lance of the wheeled platform to an inside of a pipe that is being rotated about its centerline axis. The cement-mortar mixture is discharged at a predetermined rate from the lance into the rotating pipe. The lance is withdrawn from the inside of the pipe at a predetermined rate using the wheeled platform. A tower can be provided for lowering, raising and lateral movement of the lance. At least one positioning motor can be provided for adjusting the position of the wheeled platform relative to the pipe. At least one proximity switch can provided for guiding the wheeled platform within the limits of operation. A jack screw can be provided for vertically adjusting the lance.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a perspective view of a mobile cart according to one embodiment of the invention; and

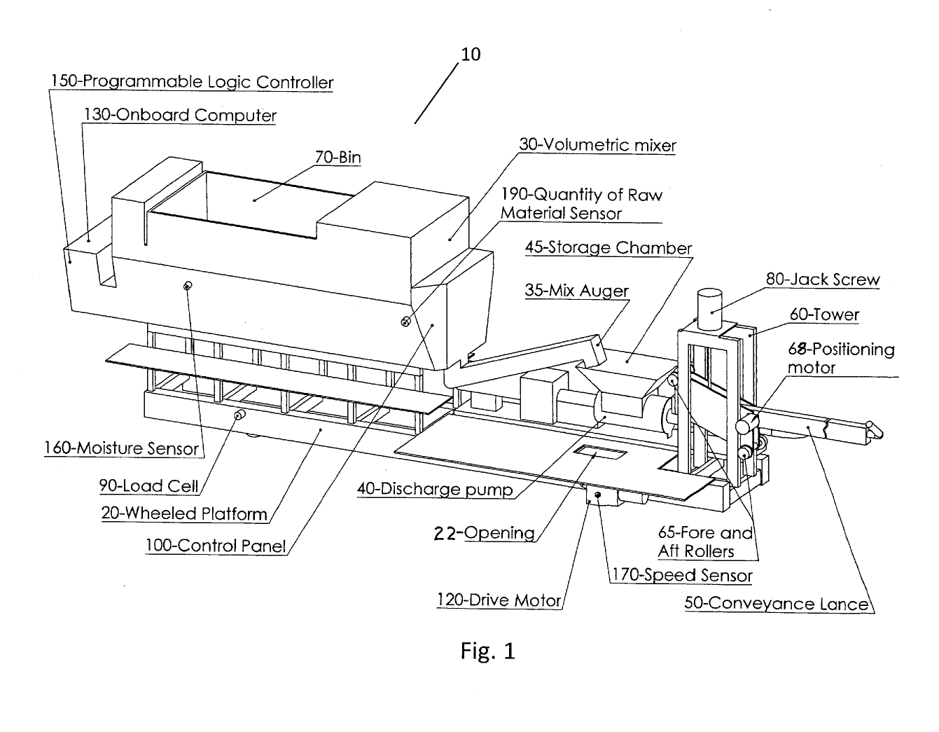

FIG. 2 is a perspective view of a mobile cart according to one embodiment of the invention.

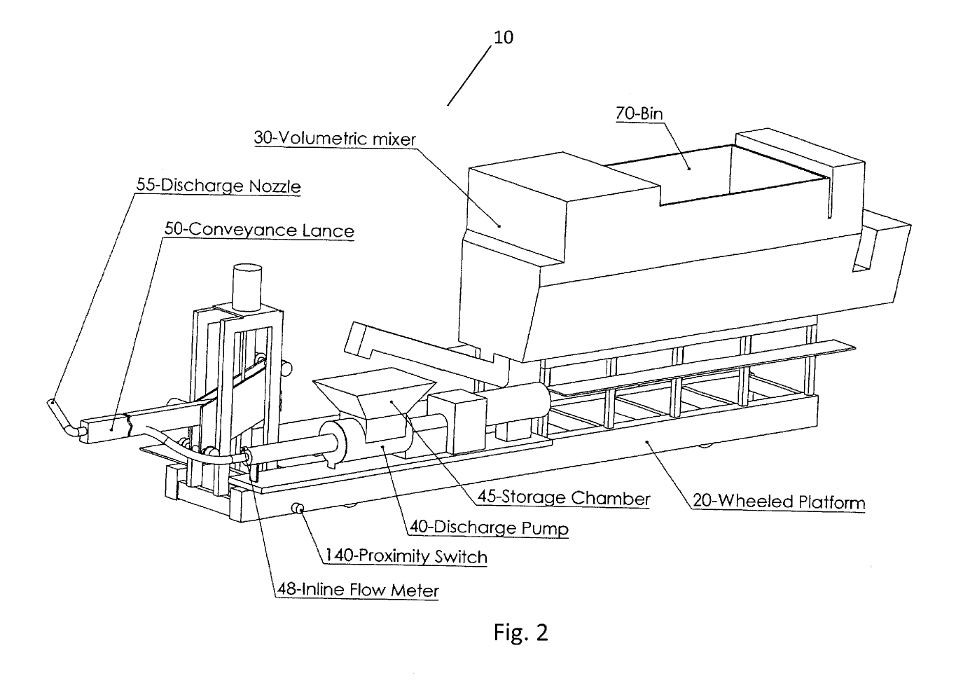

Similar reference characters refer to similar parts throughout the several views of the drawings.

### DETAIL DESCRIPTION OF THE INVENTION

American SpiralWeld has developed a mobile cart that eliminates the need for the “stationary equipment” as described above. The mobile cart of the present invention removes the necessity for all stationary mixing equipment by consolidating the raw materials (fine aggregate, cement, curing retardant and water) storage, volumetric mixing unit, discharge pump and lance on a mobile cart. The mobile cart of the present invention will incorporate PLCs (programmable logic controllers) to monitor and direct the operation of its components throughout the process, and will roll on tracks to facilitate movement to and from the rotating pipe application location.

The mobile cart of the present invention houses equipment that will mix, transport and discharge a high-slump cement-mortar mixture through a lance to the inside of a pipe that is being rotated about its centerline axis. The cement-mortar mixture is to be discharged at a predetermined rate from the lance into the rotating pipe while the lance is withdrawn from the inside of the pipe at a predetermined rate by the mobile cart.

The mobile cart 10 of the present invention consists of a wheeled platform 20 for supporting and transporting a volumetric mixer 30, a discharge pump 40 and a conveyance lance 50 through which the fluid cement mixture travels prior to being discharged into a rotating pipe (not shown). The mixer 30 is a standard volumetric mixer complete with self-contained bins 70 for raw materials comprised of sand, cement, water and chemical add-mixture. The mixer 30 is placed on the tail end of the wheeled platform 20 facing forward to minimize transport distance of the mixture to the discharge pump 40. The elevation of the mixer 30 is sufficiently higher than that of the discharge pump 40 to facilitate efficient discharge of the mixture through the mix auger 35 while it is inclined at the optimum operational angle. The mixer 30 discharges the mixture from its mix auger 35 into an open-air input receptacle on top of the discharge pump's storage chamber 45. The mixer 30 and discharge pump 40 are not physically connected, but the discharge pump 40 sits forward of the mixer 30 on the wheeled platform 20. The discharge pump 40 transfers mixture from the storage chamber 45, through an inline flow meter 48, to the lance 50. Connection between the flow meter 48 and lance 50 inlet is accomplished by a flexible pipe and sleeve clamps. The lance 50 is mounted on a tower 60 located at the head of the wheeled platform 20 which can accommodate lateral adjustment via a positioning motor 68 to assist in providing optimum lateral positioning of the lance discharge nozzle 55. The lance 50 is connected to the tower 60 via fore and aft rollers 65 which counter the moment resulting from the weight of the lance 50 and allow for vertical adjustment of the height of the lance 50 to facilitate optimum height of the discharge nozzle 55 relative to varying pipe sizes. Vertical adjustment of the lance 50 is accomplished by an electrically actuated jack screw 80. The floor of the wheeled platform 20 includes an opening 22 centered just aft of the tower 60, below the end of the mix auger 35, to allow for removal of any excess mixture as well as wash down waste and water. The axles of the wheeled platform 20 are configured with integrated load cells 90 to allow the weight of the wheeled platform 20 to be measured while static or in operational translation mode.

The mobile cart 10 of the present invention can be operated manually or automatically. Manual operation is accomplished by an onboard operator positioned at the wheeled platform control panel 100, or a remote operator manipulating the functions of the wheeled platform 20 via either a wireless control panel or mobile pendant. In either mode, the operator has full functional control of all aspects of the mobile cart 10 of the present invention including the ability to turn on/off, operate, and start/stop mixer 30, discharge pump 40, lance 50, positioning motors 68 and translational drive motors 120, as well as control of the speed at which the mixture is produced and pumped, the translational velocity and operational stroke of the mobile cart 10, and the height and lateral position of the lance 50. All equipment on the mobile cart 10 is configured through an onboard computer 130 so that operational parameters can be monitored and recorded. Proximity switches 140 mounted on the perimeter of the wheeled platform 20 are configured through PLCs 150 to provide data to the onboard computer 130 to assist the operator in guiding the mobile cart 10 within the limits of operation, as well as modulating the mobile cart's translational velocity throughout the operational stroke. Operational parameter limits can be set in the onboard computer 130 to provide a warning to the operator and/or initiate a complete shutdown should the mobile cart 10 begin to operate outside of the set parameter limits. The mobile cart 10 can record and store operational sequences in an onboard computer 130 so that such sequences can be performed in a fully automatic mode at a future time. The automatic operation mode can be overridden at any time by the manual operator, either onboard or remotely via a wireless control panel or mobile pendant.

The mobile cart 10 automatically measures and records in an onboard database the following operational parameters: machine equipment on/off times; machine translational direction and associated start/stop times and durations; sand moisture sensor 160; translational speed sensor 170 in both operational directions at pre-determined time intervals; volume of mixture sensor 160 being discharged through the lance at pre-determined intervals while discharging mixture into pipe; quantities of raw materials sensor 190 (total weight in pounds of sand, cement, water, and chemical add-mixture) delivered per operational stroke; sequential count of operational strokes; axle load cell readings at the beginning and end of each operational stroke; axle load cell readings at pre-determined intervals during the mixture application portion of the operational stroke. The computer is configured so that these measured parameters can be sent via a wireless connection to a remote database as a redundant backup to the onboard database.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

We claim:

1. A mobile cart for lining a section of water main pipe having an interior surface comprising:
a wheeled platform;
a mixer operatively connected to said wheeled platform;
a discharge pump operatively connected to said wheeled platform; and
a lance operatively connected to said wheeled platform.

2. The mobile cart according to claim 1 further comprising a tower operatively connected to said lance.

3. The mobile cart according to claim 1 further comprising a control panel operatively connected to said wheeled platform.

4. The mobile cart according to claim 1 further comprising at least one drive motor operatively connected to said wheeled platform.

5. The mobile cart according to claim 1 further comprising at least one translational drive motor operatively connected to said wheeled platform.

6. The mobile cart according to claim 1 further comprising at least one proximity switch operatively connected to said wheeled platform.

7. The mobile cart according to claim 1 further comprising at least one programmable logic controller operatively connected to said wheeled platform.

8. The mobile cart according to claim 1 further comprising an integrated load cell operatively connected to said wheeled platform.

9. The mobile cart according to claim 1 further comprising a jack screw operatively connected to said lance.

10. The mobile cart according to claim 1 further comprising at least one bin operatively connected to said wheeled platform.

11. The mobile cart according to claim 1 further comprising at least one speed sensor operatively connected to said wheeled platform.

12. The mobile cart according to claim 1 further comprising at least one volume of mixture sensor operatively connected to said lance.

13. The mobile cart according to claim 1 further comprising at least one quantity of raw material sensor operatively connected to said mixer.

14. The mobile cart according to claim 1 further comprising at least one moisture sensor operatively connected to said mixer.

15. A mobile cart for lining a section of water main pipe having an interior surface comprising:
a wheeled platform;
a volumetric mixer operatively connected to said wheeled platform;
a discharge pump operatively connected to said wheeled platform;
a conveyance lance operatively connected to said wheeled platform;
a tower operatively connected to said lance;
a control panel operatively connected to said wheeled platform;
at least one positioning motor operatively connected to said tower;
at least one translational drive motor operatively connected to said wheeled platform;
at least one proximity switch operatively connected to said wheeled platform;
at least one programmable logic controller operatively connected to said wheeled platform;
at least one integrated load cell operatively connected to said wheeled platform;
a jack screw operatively connected to said lance;
at least one bin operatively connected to said wheeled platform;
at least one speed sensor operatively connected to said wheeled platform;
at least one volume of mixture sensor operatively connected to said lance;
at least one quantity of raw material sensor operatively connected to said mixer; and
at least one moisture sensor operatively connected to said mixer.

16. A method for using a mobile cart for lining a section of water main pipe having an interior surface comprising:
providing a wheeled platform having a mixer, a discharge pump, and a lance;
discharging a high-slump cement-mortar mixture from said lance of said wheeled platform to an inside of a pipe that is being rotated about its centerline axis, said cement-mortar mixture being discharged at a predetermined rate from said lance into the rotating pipe; and
withdrawing said lance from the inside of the pipe at a predetermined rate using said wheeled platform.

17. The method according to claim 16 further comprising providing a tower, said tower lowering, raising and laterally translating said lance.

18. The method according to claim 16 further comprising providing at least one drive motor, said drive motor adjusting the position of said wheeled platform relative to said pipe.

19. The method according to claim 16 further comprising providing at least one proximity switch; said proximity switch guiding said wheeled platform within limits of operation.

20. The method according to claim 16 further comprising providing a jack screw, said jack screw vertically adjusting said lance.
